(19) United States
(12) Patent Application Publication
(10) Pub. No.: US 2023/0175741 A1
(43) Pub. Date: Jun. 8, 2023

(54) Closed-Loop, Thermal Soak, Geothermal System

(71) Applicants: Spencer Ryan Smith Bohlander, Carmel, IN (US); Jennifer Evelyn Bohlander, Carmel, IN (US); Kyle David Swanson, Derby, KS (US)

(72) Inventors: Spencer Ryan Smith Bohlander, Carmel, IN (US); Jennifer Evelyn Bohlander, Carmel, IN (US); Kyle David Swanson, Derby, KS (US)

(21) Appl. No.: 17/456,372

(22) Filed: Nov. 23, 2021

(51) Int. Cl. F24T 10/17

(52) U.S. Cl. CPC F24T 10/17

(57) ABSTRACT

Closed-loop geothermal systems operate by extracting heat from the reservoir and transporting it to the surface. To maintain high enough temperatures at the surface it is necessary to have significantly higher relative reservoir temperatures. While the thermal energy of the sub surface is abundant, reservoir rock is a natural insulator with a thermal conductivity of less than 20 BTU*in2/ft*hr*F. This low thermal conductivity prevents rapid regeneration of the reservoir temperature around the wellbore reducing the relative temperature below what is needed for electrical production. The Thermal Soak method uses time and multiple closed-loop wells to overcome the low thermal conductivity allowing for continuous production of heated fluid at surface.

### FIELD OF THE INVENTION

The present invention relates to the field of Geothermal Energy for power production. The mechanism for harnessing thermal energy and transporting it to the surface is achieved using deep, closed-loop, geothermal wells with a lateral or directional extension in the thermal recovery zone.

### BACKGROUND OF THE INVENTION

Unconventional geothermal systems offer a chance to extend the use of geothermal resources to a larger area of land masses as well as into offshore regions. Studies have shown that more than 100GWe of economically viable capacity may be available with more popular technologies such as Enhanced Geothermal Systems (EGS). EGS have been adapted to offer an alternative in energy production as they can be utilized in regions with lower relative formation temperatures that typically do not possess enough enthalpy to economically sustain a standard geothermal system. However, EGS power generation requires multiple wells, an extensive understanding of the local formation’s geophysical and geo-mechanical properties which substantially increases the capital and operating costs.

Like standard “conventional” geothermal systems, the EGS method requires production of fluid that has direct contact with the formation to transport energy from the sub-surface. A working fluid, which can be native to the formation or artificially provided, will collect heat and travel to surface where it can be expelled for a multitude of uses. This practice can be costly as there are risks of fluid loss, varying pump pressures, corrosion and scaling, formation pressure degradation and many other factors that affect efficiency and cost. Therefore, techniques are needed that overcome the disadvantages.

### SUMMARY OF THE DESCRIPTION

This invention uses a sub-surface, closed-loop, thermal soak method to harness sub-terranean thermal energy and transport it back to the surface. The entire system may consist of one parent wellbore with multiple wellbore extensions to increase the surface area and exposure to the targeted formation which may further include a heat exchanger, or it may consist of multiple single wellbores, or it may consist of multiple wellbores with multiple wellbore extensions. The thermal soak method utilizes the multiple extensions or multiple wellbores by cycling each well on and off based on the desired surface temperature and formation temp.

The thermal soak method mitigates two thermal constraints of closed-loop systems. The first is thermal recovery of the reservoir. With the low thermal conductivity of formation, rock heat transfer from the far field to the near wellbore is slow. Cycling wellbores off and on provides extended time to allow the thermal recovery of the near wellbore region. The second benefit of this method is it allows the working fluid adequate time to achieve a desirable temperature needed for power production.

The sub-surface, closed-loop well and apparatus is placed in the sub-surface environment in a targeted rock formation, i.e. 5,000 feet or greater, with a desired temperature, i.e. 350° F. or greater. The closed-loop apparatus consists of a vertical and lateral section consisting of external casing, liner, or pipe and internal stinger pipe arranged in a coaxial profile layout. The closed-loop apparatus is fully enclosed from the subsurface environment. This prevents exposure of the working fluid with the rock formation.

Thermal energy is transferred from the subsurface back to the surface by circulating a working fluid. Working fluids can be made up of water, organic fluids, inorganic fluids and combinations thereof to reduce fiction, reduce corrosion, enhance specific heat or increase conductivity. The fluid path of the working fluid is pumped from the surface through the annulus between a casing, liner, or pipe and a concentric inner pipe. In the lateral section of the well thermal energy may be transferred from the rock formation to the working fluid via thermal convection, conduction, and radiation. The heated fluid is transported back to the surface by displacing the heated fluid in the wellbore with a cooler fluid from surface. The thermal energy recovered at surface is utilized for power generation, direct heating, and other applications where heat may be used.

Transfer of thermal energy from the subsurface to the surface is the goal of any geothermal system. In closed-loop geothermal two mechanisms can be used to improve thermal extraction from the reservoir. The first is increased residence time in of the fluid in the targeted formation and the second is enhanced thermal heat transfer from the rock formation to the wellbore. A balance of these two systems is used in the Thermal Soak Method. To enhance thermal conduction and thus heat transfer from the rock formation to the exterior casing, liner, or pipe, a thermally conductive medium is used to fill the gap between two. Residence time is controlled by lateral length, number of wells in the formation and pump rate of the working fluid. In the vertical section of the wellbore minimizing heat loss to cooler formations is desired and therefore, the wellbore is thermally insulated by use of vacuum insulated tubing, enhanced cement sheaths or similar processes that yield overall lower thermal conductivity averages.

### DETAILED DESCRIPTION

Various embodiments and aspects of the inventions will be described with reference to details discussed below, and the accompanying figures will illustrate these various embodiments. The descriptions and drawings are illustrative of the invention and are not to be construed as limiting the invention. Numerous specific details are described to provide a thorough understanding of various embodiments of the present invention. However, in certain instances, well-known or conventional details are not described to provide a concise discussion of embodiments of the present inventions.

Reference in the specification to “one embodiment” or “an embodiment” or “another embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

### FIG. 1: List of Identifiers

1 - Indicates the “Parent Casing” which can consist of steel casing, steel linear, steel pipe, or steel vacuum insulated tubing and is located closest to the formation. Multiple conjoined segments are placed within the drilled rock formation creating one of two flow paths between the surface and the “casing heel”, known as the vertical section. This conjoined casing extends laterally or directionally between the heel and the toe of the well.

2 - Indicates the “Stinger Pipe” which consists of steel piping. This is a concentrically placed pipe within the parent casing. Multiple conjoined segments are placed concentrically along the length of the parent casing creating one of two flow paths between the surface and the casing heel, known as the vertical section. This conjoined casing extends laterally or directionally between the casing heel and stops short of the toe. Stopping short of the toe provides volume for the fluid paths to change direction and placement of an expandable permanent plug.

3 - Indicate the “Heel” of the wellbore. This is where the “Vertical” and “Lateral” or “Directional” sections of the wellbore meet.

A1 - This is placed near the surface of the wellbore and represents the “Vertical Annulus” which is one of two fluids path of the working fluid between the surface and the heel.

A2 - This is placed in the vertical section of the wellbore and represents the “Vertical Stinger Path” which is one of two fluids path of the working fluid between the surface and the heel.

B1 - This is placed in the lateral or directional section of the wellbore and represents the “Lateral Annulus” or “Directional Annulus” which is a continuation of the fluid path from the vertical annulus path of the working fluid between the heel and expandable permanent plug.

B2 - This is placed in the lateral or directional section of the wellbore and represents the “Lateral Stinger Path” or “Directional Stinger Path” which is a continuation of the fluid path from the vertical stinger path of the working fluid between the heel and the end of the stinger pipe.

C - This is the “Expandable Permanent Plug”, it is used seal the parent casing at the toe and isolate the working fluid so that it does not make contact the rock formation.

D - Indicator of the “Toe” of the parent casing and the end of the wellbore.

E - The “Targeted Thermal Area” is a depth represented by a top and bottom vertical depth in which the lateral or directional section of the well is located. The top and bottom depth represent the min and max temperatures desired for adequate heat transfer. The targeted thermal area may cross multiple rock formations as the depth and temperature are considered the most important.

E, G, H, I - Each of these indicate potential different rock formation that have to be drilled in order to reach the desired depth and targeted thermal area.

J - represents the first full formation that will have to be drilled through. Generally, this is a water aquifer.

FIG. 1 illustrates a diagram of an embodiment of a single closed loop apparatus, referred to as a single wellbore. Two possible fluid paths exist to circulate a cold working fluid from the surface, down the vertical, back, and forth across the horizonal segment and then the heated fluid is transferred back to the surface. The first flow path would start at the Surface Annulus and travel to the Toe through the annulus. In the Lateral or Directional Annulus, the working fluid convectively adsorbs energy which is transferred from the reservoir rock. During this thermal transfer the temperature of the reservoir rock decreases. The heated fluid is then transferred back to the surface through the Stinger Pipe. In the second flow path the cold fluid starts in the stinger pipe at the surface and flows down to the toe where it reverses flow direction in the Lateral or Directional Annulus. Heat is transfer from the reservoir rock while the working fluid is again in the lateral or directional sections and then the working fluid if transferred back to the surface via the Annulus.

### FIG. 2: List of Identifiers

4 - Indicates the “Stinger Pipe” which consists of steel piping. This is a concentrically placed pipe within the parent casing. Also represented in FIG. 1 as 2.

5 - Indicates the “Parent Casing” which can consist of steel casing, steel linear, steel pipe, or steel vacuum insulated tubing and is located closest to the formation. Also represented in FIG. 1 as 1.

K - Working fluid “Surface Storage Tank”. The Surface Storage Tank could be a collection of multiple reservoir batteries that will be used to achieve a desired usable temperature.

L - represents a pump, or a device used to physically assist in changes an overall volume of fluid from a static state to a dynamic state

M - represents a “Cold” working fluid being injected into a flow-out manifold and how it may connect to multiple wells with the ability to isolate each well.

N - represents returning “Hot” working fluid from subsurface and flowing into a concept of the flow-in manifold and how it may connect to multiple wells with the ability to isolate each well.

FIG. 2 illustrates diagram of an embodiment of a possible general layout and possible equipment where multiple fluid flow paths traveling from surface to the targeted formation to collect heat and back to the surface. In this illustration the surface contains a cluster of eight wells. As is the function of the Thermal Soak Method, each of the wells can be isolated so that only a single wellbore is connected to the inflow and outflow manifolds. The ability to isolate all but a single well allows time for the reservoir rock near the “offline wells” to regenerate heat from the far field. The far field is the reservoir far from the wellbores that isn’t directly impacted, reduction in temperature, by the circulating working fluid within the wellbore. As heated fluid is cycled from wellbores, the heated fluid will be directed into the Surface Storage Tank where it is stored until recirculated down the same or next wellbore.

### FIG. 3: List of Identifiers

6 - Indicates the “Parent Casing” which can consist of steel casing, steel linear, steel pipe, or steel vacuum insulated tubing and is located closest to the formation. Also represented in FIG. 1 as 1 AND FIG. 2 as 5.

7 - Indicates the “Stinger Pipe” which consists of steel piping. This is a concentrically placed pipe within the parent casing. Also represented in FIG. 1 as 2 and FIG. 2 as 4.

O - Represents the area of a single rock formation in which the targeted thermal zone exists.

P - represents the wellbore where the formation that had previously been located was removed by the drill bit during well construction operations. This area can be filled with a different medium type to secure and/or isolate the wellbore and may be thermally conductive or isolating depending on needs.

Q - Represents the “Annulus” flow path between the Stinger pipe and external casing, Liner, or pipe. This is also represented in FIG. 1 as A1 and B1.

R - Represents the “Stinger” flow path down the center of the Stinger pipe. This is also represented in FIG. 1 as A2 and B2.

FIG. 3 illustrates diagram of an embodiment of a lateral wellbore extension placed in the thermally target area where it will collect heat. Heat is transferred from the rock formation, through the medium placed between the formation and casing, liner or tubing. Finally, the heat passes through the casing, liner, or tubing and is absorbed by the circulating working fluid.

### FIG. 4: List of Identifiers

S and U - Represent wellbore extensions with the internal working fluid static to increase heat recovery.

T - Represents a wellbore extension where the internal fluid is in a dynamic state.

FIG. 4 illustrates diagram of an embodiment of multiple wellbore extensions placed in the targeted formation to collect heat. As the target formation’s thermal conductivity is less than that of the working fluid, liner, casing, and/or tubing and the medium placed between the wellbore and external liner, casing and/or tubing, a fluid will remain static for a specified period which allows it to achieve a higher temperature for a specific volume of working fluid. This process is known as thermal soaking. The amount of time a wellbore stays in the dynamic state will be controlled using a series of valve to control fluid flow. This system is represented by the I and J in FIG. 2 above. Note that depending on fluid direction, the fluid may follow one of two paths. Travel into the wellbore to the target formation via the internal pipe and from the target formation to surface via the annulus between the internal and external pipe or the opposite where the fluid will travel into the wellbore to the target formation via the annuls between the internal and external pipe and from the target formation to surface via the internal pipe. Again, the series of valves and manifolds at surface will dictate fluid flow and be optimized to achieve a desirable flow out temperature and fluid volume.

### BRIEF DESCRIPTION OF THE DRAWINGS

The present invention is illustrated by way of example and not limitation in the figures of the accompanying drawings in which like references indicate similar elements.

FIG. 1 illustrates a potential layout of one wellbore and one wellbore extension, according to one embodiment of the present invention.

FIG. 2 illustrates the general concept of how the circulation of fluid in and out of various wellbores with the utilization of a thermally insulated reservoir at surface, according to one embodiment of the present invention.

FIG. 3 illustrates a cross sectional layout of one wellbore extension used to collect heat from the targeted formation and one example of a potential flow path through the apparatus, according to one embodiment of the present invention.

FIG. 4 illustrates a possible scenario where two wellbore extensions are static while they regain heat and with a single wellbore extension circulating fluid to collect the heat at surface, according to one embodiment of the present invention.

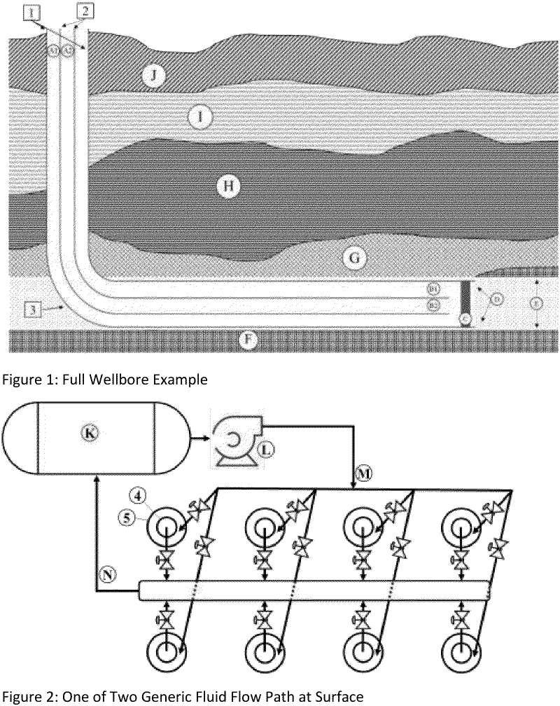

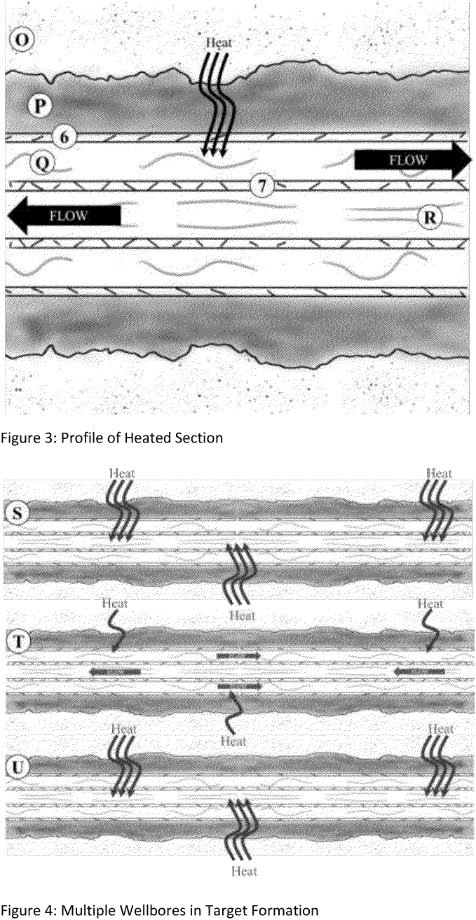

1. A wellbore designed to maximize heat transfer in the lateral section of the wellbore and minimize heat transfer in the vertical.

2. A system comprised of multiple lateral wellbore sections designed to optimize the formation’s heat recovery time when in the static state and to transfer heated fluid through displacement from the subsurface to the surface when in a dynamic state.

3. A system comprised of a single lateral wellbore section designed to optimize the formation’s heat recovery time when in the static state and to transfer heated fluid through displacement from the subsurface to the surface when in a dynamic state.
